(19) United States
(12) Patent Application Publication
(10) Pub. No.: US 2024/0121643 A1
(43) Pub. Date: Apr. 11, 2024

(54) SYSTEMS AND METHODS FOR DETERMINING MEASUREMENT RESOURCE FOR MEASURING INTERFERENCE BETWEEN NETWORK NODES

(71) Applicant: ZTE CORPORATION, Shenzhen (CN)

(72) Inventors: Xing LIU, Shenzhen (CN); Xianghui HAN, Shenzhen (CN); Xingguang WEI, Shenzhen (CN); Wei GOU, Shenzhen (CN); Shuaihua KOU, Shenzhen (CN)

(73) Assignee: ZTE CORPORATION, Shenzhen (CN)

(21) Appl. No.: 18/534,121

(22) Filed: Dec. 8, 2023

Related U.S. Application Data
(63) Continuation of application No. PCT/CN2022/080408, filed on Mar. 11, 2022.

(51) Int. Cl. H04W 24/08; H04L 5/00

(52) U.S. Cl. CPC H04W 24/08; H04L 5/0048

(57) ABSTRACT

The present disclosure relates to determining measurement resource for measuring interference, including determining, by a first network node; measurement resource configured to receive Reference Signal (RS), receiving, by the first network node from the second network node, the RS in the measurement resource, and determining interference of operations of the second network node on operations of the first network node based on the received RS.

### CROSS-REFERENCE TO RELATED APPLICATION

This application claims the benefit of priority under 35 U.S.C. § 120 as a continuation of International Patent Application No. PCT/CN2022/080408, filed on Mar. 11, 2022, the disclosure of which is incorporated herein by reference in its entirety.

### TECHNICAL FIELD

The disclosure relates generally to wireless communication networks, and in particular, to uplink and downlink resources used to carry transmissions between nodes of the wireless communication networks.

### BACKGROUND

In wireless communication systems (e.g., New Radio (NR), 4th Generation Mobile Communication Technology (4G), Long-Term Evolution (LTE), LTE-Advance (LTE-A), and 5^{th} Generation Mobile Communication Technology (5G)), a network node (e.g., User Equipment (UE) or a Base Station (BS)) can receive and transmit signals simultaneously or switch between reception and transmission without delay under full duplex or flexible duplex. In the example in which full duplex is supported, the uplink and downlink configurations of neighbor cells may be different. In such an example, time-frequency resources of network nodes with different frame structures cause cross-link interference.

### SUMMARY

The present disclosure relates to determining measurement resource for measuring interference, including determining, by a first network node; measurement resource configured to receive Reference Signal (RS), receiving, by the first network node from the second network node, the RS in the measurement resource, and determining interference of operations of the second network node on operations of the first network node based on the received RS.

The present disclosure further relates to determining an unavailable resource due to interference, including receiving, by a wireless communication device, configuration from a first base station and determining, by the wireless communication device, an unavailable resource for communicating data with the first base station. The unavailable resource is determined according to the configuration from the first base station.

### BRIEF DESCRIPTION OF THE DRAWINGS

FIG. 1 illustrates an example wireless communication system, according to various arrangements.

FIG. 2 is a diagram illustrating a time-domain resource structure used by an aggressor BS and a time-domain resource structure used by a victim BS, according to various arrangements.

FIG. 3 is a diagram illustrating a time-domain resource structure used by an aggressor BS and a time-domain resource structure used by a victim BS, according to various arrangements.

FIG. 4 is a diagram illustrating measurement resource and downlink resource of the victim BS, according to various arrangements.

FIG. 5A is a diagram illustrating frequency resources of the aggressor BS carrying the RS and frequency resources of the victim BS being affected by the frequency resources of the aggressor BS carrying the RS, according to various arrangements.

FIG. 5B is a diagram illustrating frequency resources of the aggressor BS carrying the RS and frequency resources of the victim BS being affected by the frequency resources of the aggressor BS carrying the RS, according to various arrangements.

FIG. 6 is a diagram illustrating measurement resource, downlink resource, and uplink resource of the victim BS, according to various arrangements.

FIG. 7 is a diagram illustrating measurement resource, downlink resource, and uplink resource of the victim BS, according to various arrangements.

FIG. 8 is a flowchart diagram illustrating a method for determining measurement resource, according to various arrangements.

FIG. 9 is a flowchart diagram illustrating a method for determining unavailable resource, according to various arrangements.

FIG. 10A illustrates a block diagram of an example base station, in accordance with some arrangements of the present disclosure.

FIG. 10B illustrates a block diagram of an example UE, in accordance with some arrangements of the present disclosure.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

The arrangements of the present disclosure relate to determining an appropriate interference coordination mechanism by determining the interference between nodes of a wireless communication system, sending reference signals, and measuring the interference.

Wireless communication networks such as 4G, LTE, LTE-A, and 5G face increasing demand for their usage. Based on current development trends, 4G and 5G systems are expected to support features such as Enhanced Mobile Broadband (eMBB), Ultra-Reliable Low-Latency Communication (URLLC), and Massive Machine-Type Communication (mMTC). Full duplex is required for 5G and further communication systems.

In wireless communication systems, time-domain resources are split between downlink and uplink in Time Division Duplex (TDD). Allocation of inadequate time duration for the uplink in TDD would result in reduced coverage, increased latency, and reduced capacity. To address these technical challenges of the conventional TDD operations, the simultaneous existence of downlink and uplink (i.e., full duplex) or more specifically, subband non-overlapping full duplex is implemented at the BS (e.g., gNB) side within a conventional TDD band. The subband non-overlapping full duplex cannot be supported by the conventional TDD frame structures. In the examples in which full duplex is supported, the uplink and downlink configurations of neighbor cells may differ.

FIG. 1 is an example wireless communication system 100, according to various arrangements. As shown in FIG. 1, the system 100 includes a BS 101 and a BS 102. Each BS 101 or 102 can be a wireless communication node such as but not limited to, a gNB, eNB, an access point, a Transmission/Reception Point (TRP), or so on. Each BS 101 or 102 provides wireless communication services and can communicate with (send data, signals, or messages to and receive data, signals, or messages from) wireless communication devices (e.g., UEs 121 and 122) within a geographical boundary defined by the transmission and reception capabilities of each BS 101 or 102 and the wireless communication devices with in such geographical boundary. The area defined by the geographical boundary is referred to as a cell. As shown, the BS 101 provides wireless communication services within a cell 111. The BS 102 provides wireless communication services within a cell 112.

The UEs 121 and 122 are within the cell 111, and the UE 121 is communicating with the BS 101 via link (or connections) 131 as shown. The link 131 supports uplink communications which include wireless transfer of data from the UE 121 to the BS 101 and downlink communications which include wireless transfer of data from the BS 101 to the UE 121. The UE 122 is within the cell 112 and is communicating with the BS 102 via link (or connection) 132 as shown. The link 132 supports uplink communications which include wireless transfer of data from the UE 122 to the BS 102 and downlink communications which include wireless transfer of data from the BS 102 to the UE 122.

In some examples, the term “network” refers to one or more BSs (e.g., the BS 101 and 102) that are in communication with the UEs 121 and 122, as well as backend entities and functions (e.g., a Location Management Function (LMF)). In other words, the “network” refers to components of the system 100 other than the UEs 121 and 122.

As shown, the cell 111 has an area that includes and overlaps with at least a portion of the area defined by the cell 112, due to the locations of the BS 101 and 102, as well as the transmission and reception reach of the BS 101 being configured to be greater than those of the BS 102. In some implementations, the cell 111 can be a macro cell and the cell 112 is a micro cell.

The UE 121 communicating with the BS 101 may be using the frame structure 141, and the UE 122 communicating with the BS 102 may be using the frame structure 142. Each frame structure 141 or 142 includes uplink resources (denoted as “U”) and downlink resources (denoted as “D”). Each downlink resource or uplink resource can be a time-domain resource such as an frame, subframe, slot, time interval, symbol, or so on. As shown, the frame structure 141 for at least a part of the bandwidth is configured as “DDDDU,” and the frame structure 142 for at least a part of the bandwidth is configured as “DUUUU.” For the 3 middle time-domain resources (in the dashed box), the downlink transmission of BS 101 interferes the uplink transmission of BS 102. The interference is denoted as 133. Thus, BS 101 is referred to as the aggressor BS, and BS 102 is referred to as the victim BS. In this example, the macro cell 111 is the aggressor cell and the micro cell 112 is the victim cell.

Some downlink RS can be transmitted by BS 101 for measuring by BS 102 for obtaining the interference level between the BS 101 and 102. The RSs can be at least one of Synchronization Signal and Physical Broadcast Channel Block (SSB), Primary Synchronization Signal (PSS), Secondary Synchronization Signal (SSS), Physical Broadcast Channel (PBCH) Demodulation Reference Signal (DMRS), Remote Interference Management Reference Signal (RIM-RS), Channel Status Information (CSI)-RS (e.g., periodic CSI-RS, semi-persistent CSI-RS, aperiodic CSI-RS, and so on), Physical Downlink Control Channel (PDCCH) DMRS, Physical Downlink Shared Channel (PDSCH) DMRS, and so on.

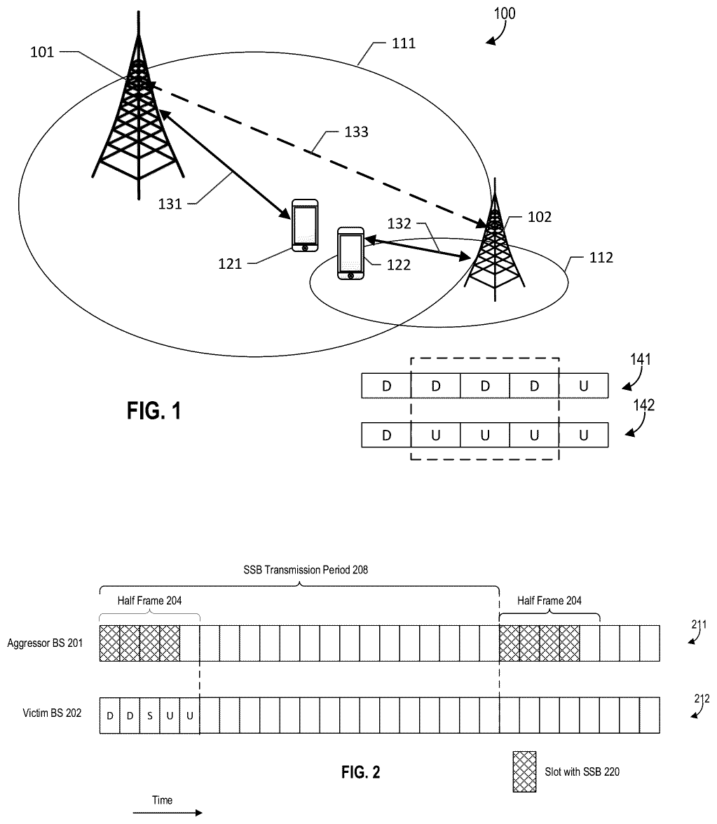

The time-domain resources used by the aggressor BS 101 to send the RSs may correspond to time-domain resources (such as downlink, uplink, and flexible resources) with any attributes at the victim BS 102. The victim BS 102 cannot transmit downlink data to or receive uplink data from the UE 122 using the time-domain resources for measuring the RSs. FIG. 2 is a diagram illustrating a time-domain resource structure 211 (e.g., frame structure) used by an aggressor BS 201 and a time-domain resource structure 212 used by a victim BS 202, according to various arrangements. An example of the aggressor BS 201 is the BS 101. An example of the victim BS 202 is the BS 102. Each box in FIG. 2 represents a time-domain resource, which is shown as a slot for example.

As an example shown in FIG. 2, SSBs transmitted by the aggressor BS 201 in slots with SSB 220 are used as the RSs for inter-BS interference measuring. The SSBs are transmitted with an SSB transmission period 208 which is shown as 2 radio frames as an example. In each SSB transmission period 208, the SSBs are located in the first half frame 204. More specifically, the time domain position of SSBs are defined in relevant specification.

One the other hand, the time-domain resource structure 212 of cell of victim BS 202 is “DDSUU” as an example, where “S” represents a flexible or special resource (e.g., a flexible slot or a flexible symbol). The flexible or special resource can be further rewritten by dynamic signaling into a downlink resource or an uplink resource or a dynamic flexible resource. In such example, the resources for measuring RS may overlap with either downlink, uplink, or flexible resource of the victim BS 202.

Given that the victim BS 202 cannot normally send or receive during the measurement, the UE should have the same understanding of the lack of capability of the victim BS 202. That is, the UE should not receive from or transmit to the BS on the relation resource. Otherwise, the performance of data transmission or measurement will be affected. For example, when measurement resources (e.g., the slots with SSB 220) overlap with downlink transmission resources (for example, downlink data carried on the PDSCH) of the victim BS 202, the victim BS 202 cancels the data transmission on the resources that overlap with measurement resources or transmits downlink data within the PDSCH by performing rate matching around measurement resources. When measurement resources overlap with uplink data transmission (for example, uplink data carried on the PUSCH) of the victim BS 202, the victim BS 202 instructs the UE to cancel or mute the transmission of data (to be transmitted by the UE to the victim BS 202) that overlap with measurement resources or indicates to the UE to transmit uplink data within the PUSCH by performing rate matching around measurement resources. In this case, the victim BS 202 needs to effectively indicate measurement resources to the UE (e.g., the UE 122), and the UE determines the actual transmission policy in accordance with its own data scheduling.

Accordingly, the arrangements disclosed herein relate to the victim BS 202 determining the measuring resources and indicating the same to the UE. The UE transmission policies based on the measurement resources and data scheduling are also defined.

In some arrangements, SSB is reused as RS for inter-BS interference measurement. More specifically, at least one of the SSS and PBCH DMRS is used for inter-BS interference measurement. The victim BS (which measures the RS) determines the measurement resource used or configured to receive the RS. The measurement resource relates to, is defined by, or can be determined based on measurement resource information such as but not limited to, one or more of Subcarrier Spacing (SCS) of the RS (e.g., SSB), RS (e.g., SSB) transmission period and offset, actual transmitted RS (e.g., SSBs), time-domain offset, frequency location of the RS (e.g., SSB), cell identifier (ID) of the cell of aggressor BS. As used herein, the time-domain measurement resource is the time-domain resource used by the victim BS to receive and measure the RS transmitted by the aggressor BS. The aggressor BS or another entity other than the victim BS (e.g., a BS different from both the aggressor BS and the victim BS) can send the measurement resource to the victim BS, so that the victim BS and determine the time-domain measurement resource.

With regard to the SCS of the SSB, the SCS can be for example one of {15 kHz, 30 kHz} under frequency range 1. In another example, the SCS can be for example one of {120 kHz, 240 kHz} under frequency range 2-1. In another example, the SCS can be for example one of {480 kHz, 960 kHz} under frequency range 2-2. In some examples in which the SCS is 30 kHz, time position case should also be indicated from case B and case C. The SCS of the SSB can be used to determine time-domain position of the SSBs.

For a half frame with SSB, the first symbol indices for candidate SSBs are determined according to the SCS of SSBs as follows, where index 0 corresponds to the first symbol of the first slot in a half-frame. In an example in which SSB is associated with 15 kHz SCS (i.e., time position case A, the first symbols of the candidate SS/PBCH blocks have indices of {2,8}+14 n. For operation without shared spectrum channel access, in the examples in which carrier frequencies smaller than or equal to 3 GHz, n=0, 1, and in the examples in which carrier frequencies within FR1 larger than 3 GHz, n=0, 1, 2, 3. For operation with shared spectrum channel access, as described in [15, TS 37.213], n=0, 1, 2, 3, 4. Other time position cases (B, C, D, E, F, G, etc.) can be similarly defined.

With regard to the SSB transmission period and offset, the maximum number of SSBs within a SSB transmission period (e.g., the SSB transmission period 208) is defined according to frequency. For example, for frequency range 0-3 GHz, the maximum number of SSBs is 4. For frequency range 3-6 GHz, the maximum number of SSBs is 8. For frequency range higher than 6 GHz, the maximum number is 64. These SSBs are located in a half frame (e.g., the half frame 204) within the SSB transmission period. In the example in which the SSB transmission period is 2 radio frames (e.g., 20 ms), there are four half-frames within the SS transmission period as shown in FIG. 2. The number of bits for indicating the offset (e.g., a location offset with the SSB transmission period) is determined according to the number of half frames within the SSB transmission period. The offset can be used for indicating in which half frame are the measurement resources for the SSB (e.g., slots with SSB 220) are located. In some examples in which 2 bits are used for indicating the offset, 00 represents the first half frame (e.g., 204), 01 represents the second half frame (e.g., the first half frame after half frame 204), 10 represents the third half frame (e.g., the second half frame after half frame 204), and 11 represents the last half frame (e.g., the last half frame in the SSB transmission period 208.

With regard to actual transmitted SSBs, the number of SSBs within an SSB transmission period such as 4 (shown in FIG. 2), 8, 64, or another value are the maximum number of SSBs with the SSB transmission period. Some of the SSBs may not be actually transmitted. A signaling can be used for indicating which SSBs are actually transmitted. For example, the signaling ssb-PositionsInBurst can be used to indicate the actual transmitted SSBs. That is, one or more bitmaps in ssb-PositionsInBurst are defined for this indication. As an example, for 8 SSBs (with indices 0-7, respectively), the signaling ssb-PositionsInBurst with 8 bits can be used for the indication. The first/leftmost bit corresponds to SSB index 0, the second bit corresponds to SSB index 1, and so on. A first value (e.g., 0) in the bitmap indicates that the corresponding SSB is not actually transmitted while a second value (e.g., 1) indicates that the corresponding SSB is actually transmitted.

In some arrangements, an time-domain offset needs to be considered for determining the time position of measurement resource. The time-domain offset includes at least one of transmission delay from the aggressor BS to the victim BS and timing difference between the aggressor BS and the victim BS (or between the aggressor cell and the victim cell). The time-domain offset can be indicated in terms of symbols or slots in a reference SCS. The reference SCS can be the SCS of SSB in some examples. Alternatively, the reference SCS can be the maximum SCS in the downlink frequency information list of the cell of the victim BS. The time-domain offset can 1/X or X times of the length of symbol or slot in the reference SCS, where X is an integer.

The transmission delay depends on the distance between aggressor BS and victim BS. As an example shown in FIG. 2, the SSB transmitted by aggressor BS occupies symbols 2-5, if the transmission delay is smaller than 1 symbol, then, the measurement resource for this SSB will be symbols 2-6.

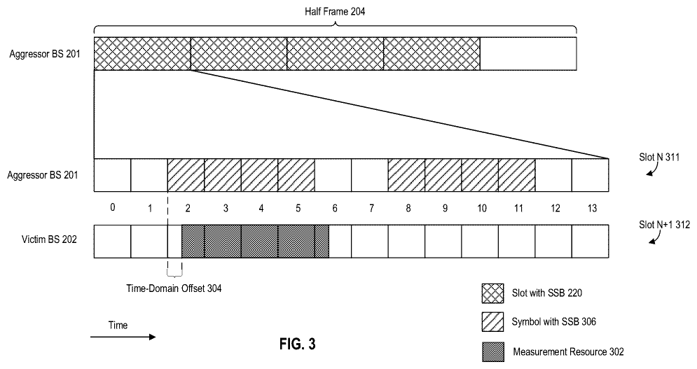

FIG. 3 is a diagram illustrating a time-domain resource structure used by the aggressor BS 201 and a time-domain resource structure used by a victim BS 202, according to various arrangements. For the half frame 204 used by the aggressor SB 201 to transmit RS (e.g., SSB) shown in FIG. 2, which has three slots with SSB 220. A slot with SSB 220 is shown as the slot 311 in FIG. 3. In some examples, the frame structures used by the aggressor BS 201 and the victim BS 202 corresponds to a frequency of 15 kHz. Each of the slots 311 and 312 has 14 symbols, with indices 0-13.

Regarding timing difference between aggressor BS 201 and victim BS 202 (or between aggressor cell and victim cell) and as shown in FIG. 2, the time difference between aggressor BS 201 and victim BS 202 is one slot. For example, the slot 311 has an index of N. A slot 312 used by the victim BS 202 that aligns or overlaps with the slot 311 has an index N+1. That is, the border of slot N 311 is aligned with the border of slot N+1 312. If SSB transmitted by aggressor BS 201 in slot N 311, the measurement resource 302 at the victim BS 202 for this SSB is in slot N+1.

As shown, the aggressor BS 201 transmits the SSB in symbols with SSB 306 (e.g., symbols 2-5 and 8-11) of slot N 311. The victim BS receives the SSB in the measurement resource 302 in symbols 2-6 in slot N+1 312. The beginning of the measurement resource 302 is offset from the beginning of the transmission resource of the aggressor BS 201 for SSB by the time-domain offset 304 as shown. Likewise, the ending of the measurement resource 302 is offset from the ending of the transmission resource of the aggressor BS 201 for SSB by the time-domain offset 304 as shown.

With regard to the frequency location of the SSB, the center frequency of SSB is indicated as the frequency location of the SSB. In some examples in which the SSB has 240 resource elements, the center frequency of SSB can be defined as the center of the resource elements, which has the resource element index 120. The frequency location of the SSB is located at a frequency point identified by an Absolute Radio Frequency Channel Number (ARFCN).

With regard to cell ID, a Physical Cell ID (PCI) of the cell of aggressor BS 201 can be indicated for determine the RS such as PSS, SSS, PBCH DMRS sequence.

In some arrangements, in order to perform the measurement, certain time-frequency resources are not used for normal data transmission or reception for communications among the victim BS and UEs communicating therewith. The time-frequency resource range can be determined by the victim BS. In some arrangements, the victim BS sends the time-frequency resource range to the UEs communicating therewith so that those UEs are aware.

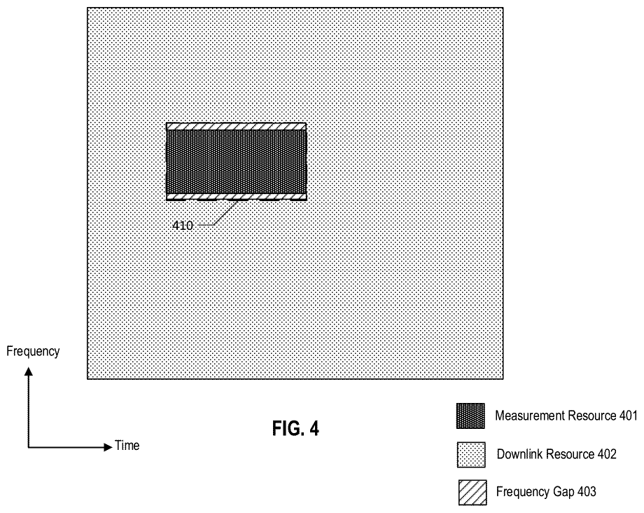

In some arrangements, the measurement may impact on downlink data transmission (e.g., carried on PDSCH) by the victim BS. FIG. 4 is a diagram illustrating measurement resource 401 and downlink resource 402 of the victim BS, according to various arrangements. The measurement resource 401 and downlink resource 402 are time-frequency resources. As shown in FIG. 4, the measurement resource 401 (which the victim BS can determine according to methods described herein) fully overlaps with downlink resource 402 of the victim BS. That is, the entirety of the measurement resource 401 are within the downlink resource 402.

For performing the measurement, the victim BS is in the receiving state on the measurement resource 401, while on the adjacent frequency of the measurement resource 401, the victim BS is in the transmitting state for transmitting downlink data to the UEs. This generates self-interference. That is, the transmit power of victim BS at the adjacent frequency of downlink resource 402 leaks into the measurement resource 401, thus affecting the performance of its own measurement of reference signals. Therefore, a frequency gap between measurement resource 401 and downlink transmission (e.g., the downlink resource 402) is reserved for avoiding the self-interference. The frequency gap can be defined or configured as a number of Resource Elements (REs) or Resource Blocks (RB). The time-frequency resource within the frequency gap is not to be used for downlink data transmission by the victim BS. Accordingly, UE receiving downlink data (e.g., carried on PDSCH) from the victim BS performs rate matching around the measurement resource and frequency gap.

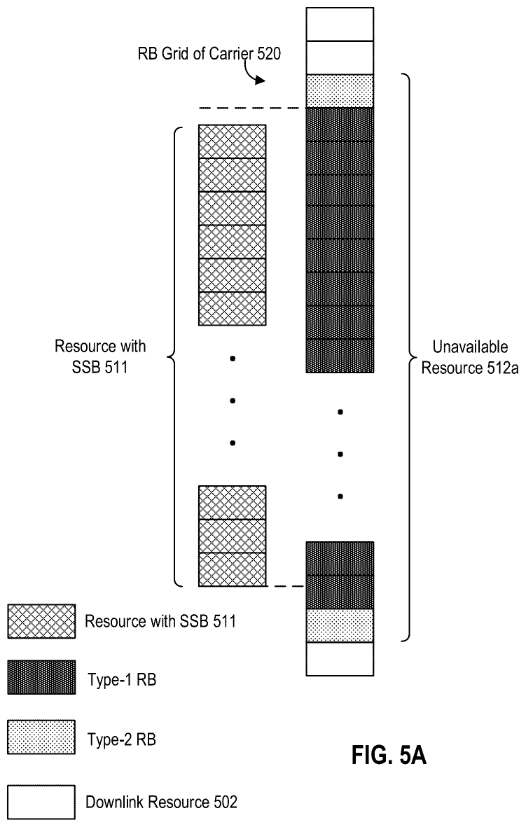

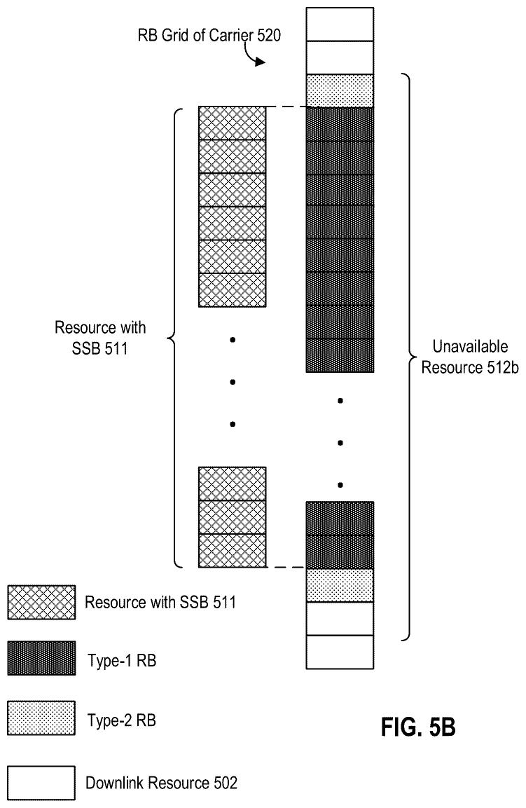

FIGS. 5A and 5B are diagrams illustrating frequency resources of the aggressor BS carrying the RS and frequency resources of the victim BS being affected by the frequency resources of the aggressor BS carrying the RS, according to various arrangements. As shown in FIGS. 5A and 5B, the frequency resources of the aggressor BS carrying the RS (e.g., SSB) include resource with SSB 511. The aggressor BS sends the SSB to the victim BS using the resource with SSB 511, which may have 240 REs in one example. As shown in FIGS. 5A and 5B, the measurement resource (denoted as Type-1 RBs) to receive the SSB fully overlaps with and are within the downlink resource 502 of the victim BS, in the frequency domain. In some examples, at least one RB is reserved as the frequency gap (denoted as Type-2 RBs) on both sides (e.g., the highest frequency end and the lowest frequency end) of the measurement resource. The combination of the Type-1 RBs and Type-2 RBs is the unavailable resource 512a and 512b, which cannot be used by the victim BS to transmit downlink data. The unavailable resource 512a may have 23 PRBs, and the unavailable resource 512b may have 22 PRBs. The unshaded boxes in FIGS. 5A and 5B can be used by the victim BS to transmit downlink data to UEs. As shown in FIG. 4, the unavailable resource 410, which corresponds to the unavailable resource 512a or 512b, includes the measurement resource 401 as well as a frequency gap 403 on either end of the measurement resource 401 in the frequency domain, where the frequency gap 403 is between the measurement resource 401 and the downlink resource 402 in the frequency domain.

There are two cases for different relationships between frequency location of the resource with SSB 511 (aggressor BS) and the RB grid of the carrier 520 (victim BS). As shown in FIG. 5A, the border or boundary of resource with SSB 511 is not aligned with RB grid of the carrier 520 in the frequency domain. This means that the center of the first resource element (e.g., RE) of the SSB 511 can be different in the frequency domain as compared to the center of the first resource element (e.g., RE) of a resource block(e.g., RB) of the downlink resource 502. On the other hand, as shown in FIG. 5B, the border or boundary of resource with SSB 511 is aligned with RB grid of the carrier 520 in the frequency domain. This means that the center of the first resource element (e.g., RE) of the SSB 511 is the same in the frequency domain as compared to the center of the first resource element (e.g., RE) of a resource block(e.g., RB) of the downlink resource 502.

In such examples, in addition to the measurement resource (e.g., the RBs overlapping the resource with SSB 511 transmitted by aggressor BS), the frequency gap (e.g., Type-2 RBs) should set such that the frequency gap is unavailable for downlink data transmission by the victim BS. As shown, the two frequency gap type-2 RBs are adjacent to or directly next to type-1 RBs on the high-frequency end of the type-1 RBs and the low-frequency end of type-1 RBs. In some arrangements, the frequency gap is adjacent to the measurement resource on a high-frequency end of the measurement resource and on a low-frequency end of the measurement resource.

More specifically, there are totally 23 RBs in FIG. 5A and 22 RBs in FIG. 5B. The victim BS can transmit information identifying the unavailable resource (e.g., the frequency position of the unavailable resources 512a and 512b) to the UE. The frequency position of the unavailable resources 512a and 512b includes the beginning and end frequency positions of the unavailable resources 512a and 512b. With this information, in response to the UE detecting that any allocated downlink resource (e.g., PDSCH) that overlaps with the unavailable resource, the UE determines that the allocated downlink resource (e.g., certain RBs) is unavailable for PDSCH in the OFDM symbols of measurement resource. In some arrangements, the first network node determines an unavailable resource. The unavailable resource includes the measurement resource and a frequency gap. At least a portion of the frequency gap is between the measurement resource and a first downlink frequency resource of the first network node, and the measurement resource overlaps with at least a portion of a second downlink frequency resource. The first network node sends to a third network node (e.g., a UE communicating with the first network node) information identifying the unavailable resource. In some arrangements, the third network node determines that any resource of downlink transmission that overlaps with the unavailable resource is unavailable to be used to receive downlink transmission from the first network node.

In some arrangements, in order to perform the measurement, certain time-frequency resources are not used for normal data transmission or reception for communications among the victim BS and UEs communicating therewith. The time-frequency resource range can be determined by the victim BS. In some arrangements, the victim BS sends the time-frequency resource range to the UEs communicating therewith so that those UEs are aware.

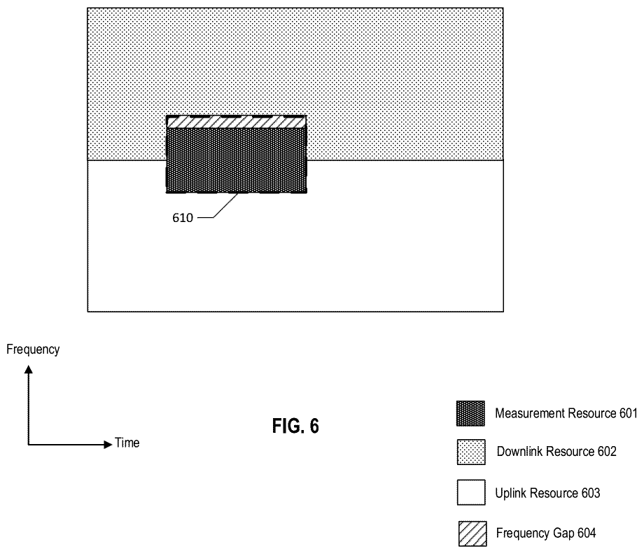

In some arrangements, the measurement may impact on downlink data transmission (e.g., carried on PDSCH) and uplink data transmission (e.g., carried on PUSCH) of the victim BS. FIG. 6 is a diagram illustrating measurement resource 601, downlink resource 602, and uplink resource 603 of the victim BS, according to various arrangements. The measurement resource 601, the downlink resource 602, and the uplink resource 603 are time-frequency resources. As shown in FIG. 6, a portion of the measurement resource 601 overlaps with a portion of the downlink resource 602 of the victim BS. Another portion of the measurement resource 601 overlaps with a portion of the uplink resource 603 of the victim BS. In other words, the measurement resource 601 overlaps with both the downlink resource 602 and the uplink resource 603. The measurement resource 601 of the victim BS can determine according to methods described herein.

In some arrangements, to reduce the impact on downlink, a frequency gap is introduced between the measurement resource 601 and downlink transmission. To reduce the impact on uplink transmission, the victim BS is in the receiving state on the measurement resource 601, while on the adjacent frequency of the measurement resource 601, the victim BS is also in the receiving state. There will be no self-interference if the victim BS simultaneously preforms both measurement on measurement resource 601 and reception uplink transmission on the frequency adjacent to the measurement resource 601. Accordingly, no frequency gap is required between the measurement resource 602 and uplink transmission in the uplink resource. While the uplink resource 603 is shown to have a lower frequency range than the downlink resource 602 and that the frequency gap 604 is adjacent or contacting the high-frequency end of the measurement resource 601, it is also possible that the uplink resource 603 has a higher frequency range than the downlink resource 602 (flipped with respect to example shown in FIG. 6) and that the frequency gap 604 is adjacent or contacting the low-frequency end of the measurement resource 601. In some arrangements, the measurement resource overlaps with at least a portion of an uplink frequency resource. The frequency gap is adjacent to the measurement resource on one end of the measurement resource.

As shown in FIG. 6, for a UE, the unavailable resource 610 for uplink data transmission or downlink data reception for the victim BS is marked as dotted box. More specifically, in response to determining that an allocated downlink resource (e.g., PDSCH resource) overlaps with the unavailable resource 610 (including the measurement resource 601 and the frequency gap 604), the UE determines that the unavailable resource 610 (e.g., the RBs thereof) is unavailable for the PDSCH in the OFDM symbols of measurement resource. In response to determining that an allocated uplink resource (e.g., PUSCH) overlaps with the measurement resource 601, the UE determines that the measurement resource 601 (e.g., the RBs thereof), without any frequency gap between the measurement resource 601 and the uplink resource 603 immediately adjacent to the measurement resource, are unavailable for the PUSCH in the OFDM symbols of measurement resource.

In some arrangements, in order to perform the measurement, certain time-frequency resources are not used for normal data transmission or reception for communications among the victim BS and UEs communicating therewith. The time-frequency resource range can be determined by the victim BS. In some arrangements, the victim BS sends the time-frequency resource range to the UEs communicating therewith so that those UEs are aware.

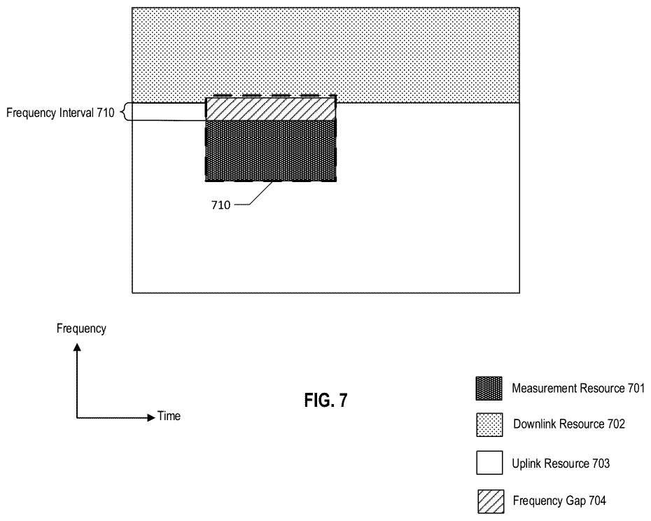

In some arrangements, the measurement may impact on downlink data transmission (e.g., carried on PDSCH) and uplink data transmission (e.g., carried on PUSCH) of the victim BS. FIG. 7 is a diagram illustrating measurement resource 701, downlink resource 702, and uplink resource 703 of the victim BS, according to various arrangements. The measurement resource 701, the downlink resource 702, and the uplink resource 703 are time-frequency resources. As shown in FIG. 7, the measurement resource 701 entirely overlaps with a portion of the uplink resource 703 of the victim BS. The measurement resource 701 of the victim BS can determine according to methods described herein. Thus, uplink transmission in some of the uplink resource 793 may be impacted.

For downlink data transmission, even if the measurement resource 701 does not overlap with the downlink resource 701, a frequency gap 704 is needed between the downlink data transmission in the downlink resource 702 and the measurement resource 701. Downlink data transmission may still be affected by measurement. More specifically, if the actual frequency interval 710 between the measurement resource 701 and the downlink resources 702 in the frequency domain is less than the frequency gap 704 required between measurement resource 701 and downlink data transmission (e.g., in the downlink resource 702), the measurement will impact downlink data transmission (e.g., carried on PDSCH).

As shown in FIG. 7, for a UE, the unavailable resource 710 for uplink data transmission or downlink data reception for the victim BS is marked as dotted box. More specifically, in response to determining that an allocated downlink resource (e.g., PDSCH resource) overlaps with the frequency gap 704, the UE determines that the frequency gap 704 (e.g., the RBs thereof) is unavailable for the PDSCH in the OFDM symbols of measurement resource. In response to determining that an allocated uplink resource (e.g., PUSCH) overlaps with the measurement resource 701, the UE determines that the measurement resource 701 (e.g., the RBs thereof), without any frequency gap between the measurement resource 701 and the uplink resource 703 immediately adjacent to the measurement resource, is unavailable for the PUSCH in the OFDM symbols of measurement resource. In some arrangements, the first network node determines an unavailable resource. The unavailable resource includes the measurement resource and a frequency gap. At least a portion of the frequency gap is between the measurement resource and a downlink frequency resource of the first network node. A frequency interval between the downlink frequency resource and the measurement resource is less than the frequency gap. The measurement resource and the downlink frequency resource are non-overlap. The first network node sends to a third network node information identifying the unavailable resource. In some examples, the third network node determines that any resource of downlink transmission that overlaps with the frequency gap is unavailable to be used to receive downlink transmission from the first network node. In some arrangements, the third network node determines that any resource of uplink transmission that overlaps with the measurement resource is unavailable to be used to transmit the uplink transmission to the first network node.

Otherwise, if the actual frequency interval 710 is larger than the frequency gap 704 required between measurement resource 701 and downlink data transmission in the downlink resource 702, the measurement will not impact on downlink data transmission (e.g., carried on PDSCH), and no frequency gap is needed.

In some arrangements, a UE is provided with configuration information for determining the unavailable resources for the downlink data reception from the victim BS to the UE or for uplink data transmission from the UE to the victim BS. ABS of the network (e.g., the victim BS), can transmit such information to the UE after performing inter-BS interference.

The configuration information includes the measurement resource information, which includes at least one of SCS of the SSB, SSB transmission period and offset, actual transmitted SSBs, time domain offset, frequency location of the SSB, cell ID of the cell of aggressor BS, as described. The UE can determine the measurement resource of the victim BS using the measurement resource information, based on the processes performed by the victim BS as previously disclosed. In other words, instead of the victim BS determining the measurement resource and providing the measurement resource to the UE communicating with the victim BS, the UE can be directly provided with the measurement resource information to determine the measurement resource.

In addition, the configuration information may further include frequency gap information used to determine the frequency gap. The frequency gap information can be predetermined or defined in the specification in some examples. In other examples, the victim BS can send the frequency gap information to the UE. The definition or configuration of frequency gap can be in units of RE or RB (e.g., start RE/RB index, end RE/RB index, RE/RB range, etc.). Furthermore, the frequency gap can be determined based on a reference SCS (e.g., the SCS of the SSB), a configured SCS, a SCS of the data, or a SCS of the active Bandwidth Part (BWP) of the UE. The frequency gap can be defined as multiple REs or RBs, which can below to a certain SCS. As such, different SCS may correspond to different REs or RBs. Determining the SCS can allow determination of the REs or RBs associated with that SCS. In the example in which the SCS is 15 kHz, an RE is 15 kHz, and an RB is 15*12=180 kHz. In another example in which the SCS is 30 kHz, an RE is 30 kHz, and an RB is 30*12=360 kHz. In some arrangements, the first network node sends to a third network node configuration information including at least portion of measurement resource information and a frequency gap information. The third network node determines an unavailable resource according to the configuration information.

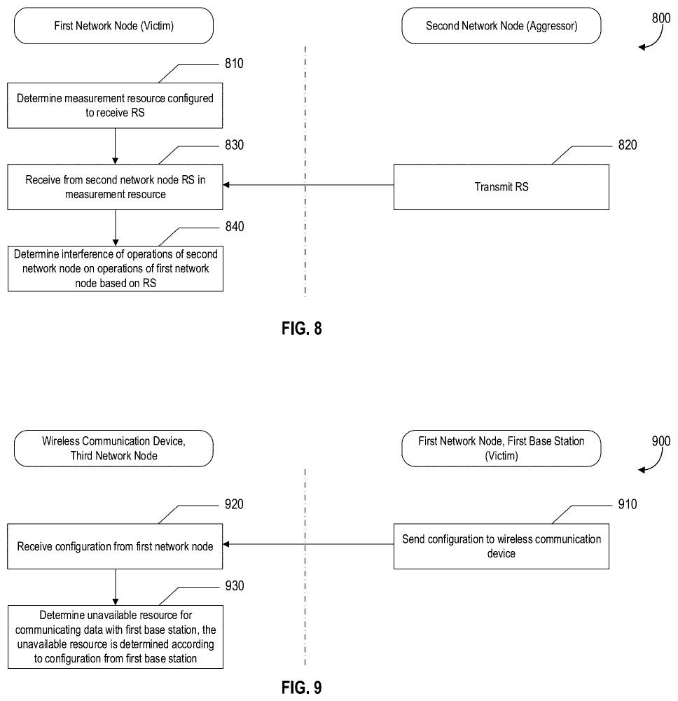

FIG. 8 is a flowchart diagram illustrating a method 800 for determining measurement resource, according to various arrangements. The method 800 can be performed by a first network node (e.g., the victim network node, such as BS 102 and 201) and a second network node (e.g., the aggressor network node, such as BS 101 and 202). At 810, the first network node determines a measurement resource configured to receive RS. At 820, the second network node transmits to the first network node the RS. At 830, the first network node receives from the second network node the RS in the measurement resource. At 840, the first network node determines the interference of operations of the second network node on operations of the first network node based on RS. In general, the larger the measured interference (e.g., the stronger the RS), the greater inference the operations of the second network node has on the operations of the first network.

In some arrangements, the RS includes at least one of SSB, PSS, SSS, PBCH DMRS, RIM-RS, CSI-RS (e.g., periodic CSI-RS, semi-persistent CSI-RS, aperiodic CSI-RS, and so on), PDCCH DMRS, or PDSCH DMRS.

In some arrangements, the first network node receives from the second network node measurement resource information. The measurement resource is determined based on the measurement resource information. In some examples, the measurement resource information includes one or more of SCS of the RS, RS transmission period and offset, actual transmitted RSs, time-domain offset, frequency location of the RS, cell ID of the cell of aggressor BS.

In some arrangements, the first network node determines an unavailable resource. The unavailable resource includes the measurement resource and a frequency gap. At least a portion of the frequency gap is between the measurement resource and a first downlink frequency resource of the first network node, and the measurement resource overlaps with at least a portion of a second downlink frequency resource. The first network node sends to a third network node (e.g., a UE communicating with the first network node) information identifying the unavailable resource. In some arrangements, the third network node determines that any resource of downlink transmission that overlaps with the unavailable resource is unavailable to be used to receive downlink transmission from the first network node.

In some arrangements, the frequency gap is adjacent to the measurement resource on a high-frequency end of the measurement resource and on a low-frequency end of the measurement resource.

In some arrangements, the measurement resource overlaps with at least a portion of an uplink frequency resource. The frequency gap is adjacent to the measurement resource on one end of the measurement resource.

In some arrangements, the first network node determines an unavailable resource. The unavailable resource includes the measurement resource and a frequency gap. At least a portion of the frequency gap is between the measurement resource and a downlink frequency resource of the first network node. A frequency interval between the downlink frequency resource and the measurement resource is less than the frequency gap. The measurement resource and the downlink frequency resource are non-overlap. The first network node sends to a third network node information identifying the unavailable resource. In some examples, the third network node determines that any resource of downlink transmission that overlaps with the frequency gap is unavailable to be used to receive downlink transmission from the first network node.

In some arrangements, the third network node determines that any resource of uplink transmission that overlaps with the measurement resource is unavailable to be used to transmit the uplink transmission to the first network node.

In some arrangements, the first network node sends to a third network node configuration information including at least portion of measurement resource information and a frequency gap information. The third network node determines an unavailable resource according to the configuration information.

FIG. 9 is a flowchart diagram illustrating a method 900 for determining unavailable resource, according to various arrangements. The method 900 can be performed by a wireless communication device such as the third network node (e.g., the UE 122) and the first network node (e.g., the victim network node, such as BS 102 and 201). At 910, the first base station sends configuration to wireless communication device. At 920, the wireless communication device receives the configuration from the first network node. At 930, the wireless communication device determines an unavailable resource for communicating data with the first base station. The unavailable resource is determined according to the configuration from the first base station.

In some arrangements, the unavailable resource includes a measurement resource and a frequency gap. The measurement resource is used by the first base station in measuring a RS received by the first base station from a second base station (e.g., the aggressor network node). At least a portion of the frequency gap is between the measurement resource and a downlink frequency resource of the first network node.

In some arrangements, the wireless communication device determines any resource of downlink transmission that overlaps with the unavailable resource or the frequency gap is unavailable to be used to receive downlink data from the first network node.

In some arrangements, the wireless communication device determines any resource of downlink transmission that overlaps with the unavailable resource or the frequency gap is unavailable to be used to receive downlink transmission from the first network node.

In some arrangements, the wireless communication device determines any resource of uplink transmission that overlaps with the unavailable resource is unavailable to be used to transmit the uplink transmission to the first network node.

In some arrangements, the frequency gap is adjacent to the measurement resource on a high-frequency end of the measurement resource and on a low-frequency end of the measurement resource.

In some arrangements, the measurement resource overlaps with at least a portion of an uplink frequency resource. The frequency gap is adjacent to the measurement resource on one end of the measurement resource.

In some arrangements, the determining the unavailable resource includes receiving from the first base station configuration information including one or more of SCS of the RS, RS transmission period and offset, actual transmitted RSs, time-domain offset, frequency location of the RS, cell ID of the cell of aggressor BS and frequency gap information.

Accordingly, the transmission resource of downlink reception or uplink transmission can be determined based on inter-BS interference measurement. More specifically, information required for determining the measurement resource, unavailable resource, and corresponding parameters can be determined as described herein. The UE under the victim BS can obtain the configuration information for determine the transmission resource efficiently by considering the impact of measurement.

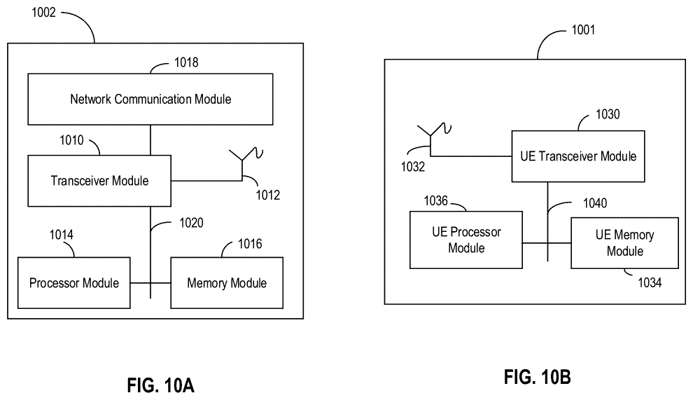

FIG. 10A illustrates a block diagram of an example base station 1002, in accordance with some arrangements of the present disclosure. FIG. 10B illustrates a block diagram of an example UE 1001, in accordance with some arrangements of the present disclosure. Referring to FIGS. 1-10B, the UE 1001 (e.g., a wireless communication device, a terminal, a mobile device, a mobile user, and so on) is an example implementation of the UEs described herein, and the base station 1002 is an example implementation of the base station described herein.

The base station 1002 and the UE 1001 can include components and elements configured to support known or conventional operating features that need not be described in detail herein. In one illustrative arrangement, the base station 1002 and the UE 1001 can be used to communicate (e.g., transmit and receive) data symbols in a wireless communication environment, as described above. For instance, the base station 1002 can be a base station (e.g., BS, eNB, and so on), a server, a node, or any suitable computing device used to implement various network functions.

The base station 1002 includes a transceiver module 1010, an antenna 1012, a processor module 1014, a memory module 1016, and a network communication module 1018. The module 1010, 1012, 1014, 1016, and 1018 are operatively coupled to and interconnected with one another via a data communication bus 1020. The UE 1001 includes a UE transceiver module 1030, a UE antenna 1032, a UE memory module 1034, and a UE processor module 1036. The modules 1030, 1032, 1034, and 1036 are operatively coupled to and interconnected with one another via a data communication bus 1040. The base station 1002 communicates with the UE 1001 or another base station via a communication channel, which can be any wireless channel or other medium suitable for transmission of data as described herein.

As would be understood by persons of ordinary skill in the art, the base station 1002 and the UE 1001 can further include any number of modules other than the modules shown in FIGS. 10A and 10B. The various illustrative blocks, modules, circuits, and processing logic described in connection with the arrangements disclosed herein can be implemented in hardware, computer-readable software, firmware, or any practical combination thereof. To illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. The arrangements described herein can be implemented in a suitable manner for each particular application, but any implementation decisions should not be interpreted as limiting the scope of the present disclosure.

In accordance with some arrangements, the UE transceiver 1030 includes a radio frequency (RF) transmitter and a RF receiver each including circuitry that is coupled to the antenna 1032. A duplex switch (not shown) may alternatively couple the RF transmitter or receiver to the antenna in time duplex fashion. Similarly, in accordance with some arrangements, the transceiver 1010 includes an RF transmitter and a RF receiver each having circuitry that is coupled to the antenna 1012 or the antenna of another base station. A duplex switch may alternatively couple the RF transmitter or receiver to the antenna 1012 in time duplex fashion. The operations of the two-transceiver modules 1010 and 1030 can be coordinated in time such that the receiver circuitry is coupled to the antenna 1032 for reception of transmissions over a wireless transmission link at the same time that the transmitter is coupled to the antenna 1012. In some arrangements, there is close time synchronization with a minimal guard time between changes in duplex direction.

The UE transceiver 1030 and the transceiver 1010 are configured to communicate via the wireless data communication link, and cooperate with a suitably configured RF antenna arrangement 1012/1032 that can support a particular wireless communication protocol and modulation scheme. In some illustrative arrangements, the UE transceiver 1010 and the transceiver 1010 are configured to support industry standards such as the Long Term Evolution (LTE) and emerging 5G standards, and the like. It is understood, however, that the present disclosure is not necessarily limited in application to a particular standard and associated protocols. Rather, the UE transceiver 1030 and the base station transceiver 1010 may be configured to support alternate, or additional, wireless data communication protocols, including future standards or variations thereof.

The transceiver 1010 and the transceiver of another base station (such as but not limited to, the transceiver 1010) are configured to communicate via a wireless data communication link, and cooperate with a suitably configured RF antenna arrangement that can support a particular wireless communication protocol and modulation scheme. In some illustrative arrangements, the transceiver 1010 and the transceiver of another base station are configured to support industry standards such as the LTE and emerging 5G standards, and the like. It is understood, however, that the present disclosure is not necessarily limited in application to a particular standard and associated protocols. Rather, the transceiver 1010 and the transceiver of another base station may be configured to support alternate, or additional, wireless data communication protocols, including future standards or variations thereof.

In accordance with various arrangements, the base station 1002 may be a base station such as but not limited to, an eNB, a serving eNB, a target eNB, a femto station, or a pico station, for example. The base station 1002 can be an RN, a regular, a eNB, or a gNB. In some arrangements, the UE 1001 may be embodied in various types of user devices such as a mobile phone, a smart phone, a personal digital assistant (PDA), tablet, laptop computer, wearable computing device, etc. The processor modules 1014 and 1036 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the method or algorithm disclosed herein can be embodied directly in hardware, in firmware, in a software module executed by processor modules 1014 and 1036, respectively, or in any practical combination thereof. The memory modules 1016 and 1034 may be realized as RAM memory, flash memory, ROM memory, EPROM memory, EEPROM memory, registers, a hard disk, a removable disk, a CD-ROM, or any other form of storage medium known in the art. In this regard, memory modules 1016 and 1034 may be coupled to the processor modules 1010 and 1030, respectively, such that the processors modules 1010 and 1030 can read information from, and write information to, memory modules 1016 and 1034, respectively. The memory modules 1016 and 1034 may also be integrated into their respective processor modules 1010 and 1030. In some arrangements, the memory modules 1016 and 1034 may each include a cache memory for storing temporary variables or other intermediate information during execution of instructions to be executed by processor modules 1010 and 1030, respectively. Memory modules 1016 and 1034 may also each include non-volatile memory for storing instructions to be executed by the processor modules 1010 and 1030, respectively.

The network communication module 1018 generally represents the hardware, software, firmware, processing logic, and/or other components of the base station 1002 that enable bi-directional communication between the transceiver 1010 and other network components and communication nodes in communication with the base station 1002. For example, the network communication module 1018 may be configured to support internet or WiMAX traffic. In a deployment, without limitation, the network communication module 1018 provides an 802.3 Ethernet interface such that the transceiver 1010 can communicate with a conventional Ethernet based computer network. In this manner, the network communication module 1018 may include a physical interface for connection to the computer network (e.g., Mobile Switching Center (MSC)). In some arrangements, the network communication module 1018 includes a fiber transport connection configured to connect the base station 1002 to a core network. The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one arrangement can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
determining, by a first network node; measurement resource configured to receive Reference Signal (RS);
receiving, by the first network node from the second network node, the RS in the measurement resource; and
determining interference of operations of the second network node on operations of the first network node based on the received RS.

2. The method of claim 1, wherein the RS comprises at least one of Synchronization Signal and Physical Broadcast Channel Block (SSB), Primary Synchronization Signal (PSS), Secondary Synchronization Signal (SSS), Physical Broadcast Channel (PBCH) Demodulation Reference Signal (DMRS), Remote Interference Management (RIM-RS), Channel Status Information (CSI)-RS, Physical Downlink Control Channel (PDCCH) DMRS, or Physical Downlink Shared Channel (PDSCH) DMRS.

3. The method of claim 1, further comprising receiving, by the first network node from the second network node, measurement resource information, wherein the measurement resource is determined based on the measurement resource information.

4. The method of claim 3, wherein the measurement resource information comprises at least one of Subcarrier Spacing (SCS) of the RS, RS transmission period and offset, actual transmitted RSs, time-domain offset, frequency location of the RS, or cell identifier (ID) of the cell of aggressor BS.

5. The method of claim 1, further comprising:
determining, by the first network node, an unavailable resource, wherein the unavailable resource comprises the measurement resource and a frequency gap, wherein at least a portion of the frequency gap is between the measurement resource and a first downlink frequency resource of the first network node, and the measurement resource overlaps with at least a portion of a second downlink frequency resource; and
sending, by the first network node to a third network node, information identifying the unavailable resource.

6. The method of claim 5, wherein the third network node determines that any resource of downlink transmission that overlaps with the unavailable resource is unavailable to be used to receive downlink transmission from the first network node.

7. The method of claim 5, wherein the frequency gap is adjacent to the measurement resource on a high-frequency end of the measurement resource and on a low-frequency end of the measurement resource.

8. The method of claim 5, wherein
the measurement resource overlaps with at least a portion of an uplink frequency resource; and
the frequency gap is adjacent to the measurement resource on one end of the measurement resource.

9. The method of claim 1, comprising:
determining, by the first network node, an unavailable resource, wherein the unavailable resource comprises the measurement resource and a frequency gap, wherein at least a portion of the frequency gap is between the measurement resource and a downlink frequency resource of the first network node, a frequency interval between the downlink frequency resource and the measurement resource is less than the frequency gap, and the measurement resource and the downlink frequency resource are non-overlap; and
sending, by the first network node to a third network node, information identifying the unavailable resource.

10. The method of claim 9, wherein the third network node determines that any resource of downlink transmission that overlaps with the frequency gap is unavailable to be used to receive downlink transmission from the first network node.

11. The method of claim 9, wherein the third network node determines that any resource of uplink transmission that overlaps with the measurement resource is unavailable to be used to transmit the uplink transmission to the first network node.

12. The method of claim 1, further comprising sending, by the first network node to a third network node, configuration information comprising at least portion of measurement resource information and a frequency gap information, wherein the third network node determines an unavailable resource according to the configuration information.

13. A first network node, comprising:
at least one processor configured to:
determine measurement resource configured to receive Reference Signal (RS);
receive, via a receiver from the second network node, the RS in the measurement resource; and
determine interference of operations of the second network node on operations of the first network node based on the received RS.

14. A wireless communication method, comprising:
sending, by a second network node to a first network node, a Reference Signal (RS) in a measurement resource configured to receive the RS,
wherein interference of operations of the second network node on operations of the first network node is determined based on the RS.

15. A second network node, comprising:
at least one processor configured to:
send, via a transmitter to a first network node, a Reference Signal (RS) in a measurement resource configured to receive the RS,
wherein interference of operations of the second network node on operations of the first network node is determined based on the RS.

16. The second network node of claim 15, wherein the RS comprises at least one of Synchronization Signal and Physical Broadcast Channel Block (SSB), Primary Synchronization Signal (PSS), Secondary Synchronization Signal (SSS), Physical Broadcast Channel (PBCH) Demodulation Reference Signal (DMRS), Remote Interference Management (RIM-RS), Channel Status Information (CSI)-RS, Physical Downlink Control Channel (PDCCH) DMRS, or Physical Downlink Shared Channel (PDSCH) DMRS.

17. The second network node of claim 15, wherein the at least one processor is configured to:
send, to the first network node, measurement resource information, wherein the measurement resource is determined based on the measurement resource information.

18. The second network node of claim 17, wherein the measurement resource information comprises at least one of Subcarrier Spacing (SCS) of the RS, RS transmission period and offset, actual transmitted RSs, time-domain offset, frequency location of the RS, or cell identifier (ID) of the cell of aggressor BS.

19. The second network node of claim 15, wherein the first network node determines an unavailable resource, wherein the unavailable resource comprises the measurement resource and a frequency gap, wherein at least a portion of the frequency gap is between the measurement resource and a first downlink frequency resource of the first network node, and the measurement resource overlaps with at least a portion of a second downlink frequency resource; and
wherein the first network node sends to a third network node information identifying the unavailable resource.

20. The second network node of claim 19, wherein the third network node determines that any resource of downlink transmission that overlaps with the unavailable resource is unavailable to be used to receive downlink transmission from the first network node.
